(19) United States
(12) Patent Application Publication
(10) Pub. No.: US 2024/0125598 A1
(43) Pub. Date: Apr. 18, 2024

(54) SYSTEM FOR SIMULTANEOUSLY MEASURING SURFACE FLOW VELOCITIES AT MULTIPLE POINTS IN STREAM USING DIGITAL BEAMFORMING RADAR

(71) Applicant: Skytrio Co., Ltd., Daejeon (KR)

(72) Inventor: Tai Hyung KIM, Daejeon (KR)

(73) Assignee: Skytrio Co., Ltd., Daejeon (KR)

(21) Appl. No.: 17/972,612

(22) Filed: Oct. 25, 2022

(30) Foreign Application Priority Data
Oct. 17, 2022 (KR) 10-2022-0133385

(51) Int. Cl. G01C 13/00; G01S 13/58

(52) U.S. Cl. CPC G01C 13/006; G01S 13/58

(57) ABSTRACT

Disclosed is a system for simultaneously measuring surface flow velocities at multiple points in a stream using a digital beamforming radar for simultaneously measuring surface flow velocities at several points in a river or a stream using multiple beams generated through a digital beamforming algorithm, and creating a flow velocity profile for the entire river or stream width in addition to a flow velocity at a specific point based thereon.

### BACKGROUND OF THE INVENTION

### Field of the Invention

The present invention relates to a surface flow velocity measurement system, and more particularly to a system for simultaneously measuring surface flow velocities at multiple points in a stream using a digital beamforming radar for simultaneously measuring surface flow velocities at several points in a river or a stream using multiple beams generated through a digital beamforming algorithm, and creating a flow velocity profile for the entire river or stream width in addition to a flow velocity at a specific point based thereon.

### Description of the Related Art

Recently, occurrence of climate change due to global warming causes an early or late monsoon, a typhoon, torrential rain, etc. As a result, riverside flooding and casualties are occurring.

However, accuracy of precipitation and damage prediction is lowered due to abrupt climate abnormalities. Therefore, importance of a monitoring system based on accurate flow velocity measurement in rivers and streams is significantly high in order to respond to flood damage and efficiently manage water resources.

To this end, flow velocities are measured, and streams are monitored using various methods. In the past, a method of measuring a flow velocity by direct contact with water has been Used by installing a device in water. However, such a direct contact hydrometer has problems in that installation and maintenance in addition to measurement are difficult in situation where a flow velocity or a flow rate is high due to high resistance to water, costs for initial input and operation are high, and there is a high rids of loss due to floods, etc.

In recent years, a non-contact measurement method of measuring a surface flow velocity of a river using an image or an ultrasonic/electromagnetic wave has been emerging as an alternative.

An electromagnetic wave surface hydrometer has an advantage of being able to measure the surface flow velocity without contact with water or regardless of day and night using a principle in which an electromagnetic wave of a certain frequency is generated and reflected on a surface of water, and then a reflected electromagnetic wave is received, and a Doppler frequency is obtained and converted into a flow velocity.

In such an electromagnetic wave surface hydrometer, a flow velocity measurement range is determined according to characteristics of an electromagnetic wave transmission/reception antenna for measurement due to characteristics of electromagnetic Waves, measurement of an average flow velocity in a specific region including a location where a radio wave is actually aimed is performed, and is Significantly important to accurately manage a measurement location along with accurately measuring a flow velocity in monitoring a flow velocity in a river or a stream.

However, a conventional general electromagnetic wave surface hydrometer may only measure a flow velocity for one specific point in a river or a stream after being installed to face a water surface of a stream on a bridge or embankment, and has a problem in that measurement accuracy may deteriorate since a measurement point may include a point where a water depth is temporarily shallow due to an embankment other than a water surface, stone, a rock, sediment, etc. when facing a measurement point on a riverside in a situation where various river shapes are present.
Republic of Korea Patent Registration No. 10-0204980 (Mar. 31, 1999)

### SUMMARY OF THE INVENTION

Therefore, the present invention has been made in view of the above problems, and it is an object of the present invention to provide a system for simultaneously measuring surface flow velocities at multiple points in a stream using a digital beamforming radar capable of simultaneously measuring surface flow velocities at several points in a river or a stream through a digital beamforming algorithm, and creating a flow velocity profile for the entire river or stream width based thereon.

In accordance with the present invention, the above and other objects can be accomplished by the provision of a system for measuring a stream surface flow velocity, the system including an antenna module including a transmitter configured to transmit a radio wave in a frequency band set to a selected first region in a target stream, and a receiver having a plurality of reception arrays each receiving a reflected wave of the radio wave from each of a plurality of second regions defined within the first region through digital beamforming and scanning, and a processing module including a scanning unit configured to perform a control operation so that the reception arrays receive reflected waves from a plurality of different points within the first region, a frequency analysis unit configured to analyze a frequency due to a Doppler effect of a reflected wave received through the receiver, a flow velocity calculation unit configured to calculate a surface flow velocity value using the frequency due to the Doppler effect, and a profile configuration unit configured to create a flow velocity profile for an entire width of the target stream by applying surface flow velocity values calculated from plurality of points.

The system may further include an installation module including an angle adjustment unit configured to adjust a vertical angle of the antenna module and a direction adjustment unit configured to adjust a horizontal angle of the antenna module, the installation module being configured installation in a set place, in which the scanning unit calculates a beam steering vector according to the vertical and horizontal angles of the antenna module, and performs beam scanning by reflecting the beam steering vector in reception input of the reception arrays.

The processing module may further include a collection unit configured to collect stream information including width, a shape, and geographic information of the target stream and installation information including an installation location and a measurement direction of the antenna module, and an information linkage unit configured to reflect surface flow velocity values calculated at a plurality of points together with the stream information and the installation information in connection with the profile configuration unit.

The system may further include an analysis module including a storage unit configured to store data of surface flow velocity values for a plurality of measurement points for an entire width of the target stream over time, and a data analysis unit configured to analyze data stored in the storage unit, monitor a change trend, and discriminate noise according to a temporary change Value.

The analysis module may further include a correction unit configured to generate correction information related to measurement position and an operation of the scanning unit by linkage with the information linkage unit and an analysis result of the data analysis unit.

### BRIEF DESCRIPTION OF THE DRAWINGS

The above and other objects, features and other advantages of the present invention will be more clearly understood from the following detailed description taken in conjunction with the accompanying drawings, in which:

FIGS. 1A and 1B are conceptual diagrams of a transmission/reception antenna beam pattern of the present invention;

FIG. 2 is a block diagram illustrating a configuration and connection relationship according to an embodiment of the resent invention;

FIGS. 3A and 3B are structural diagrams illustrating an installation state according to an embodiment of the present invention;

FIG. 4 is a flow velocity measurement conceptual diagram of a beamforming multibeam scan method according to an embodiment of the present invention;

FIG. 5 is a configuration diagram of a transmission/reception array antenna according to an embodiment of the present invention;

FIG. 6 is a configuration diagram of array beam arming according to an embodiment of the present invention; and

FIG. 7 is a configuration diagram of a transmission/reception circuit according to an embodiment of the present invention.

### DETAILED DESCRIPTION OF THE INVENTION

Hereinafter, a configuration of a system for simultaneously measuring surface flow velocities at multiple points in a stream using a digital beamforming radar of the present invention will be described in detail with reference to the accompanying drawings.

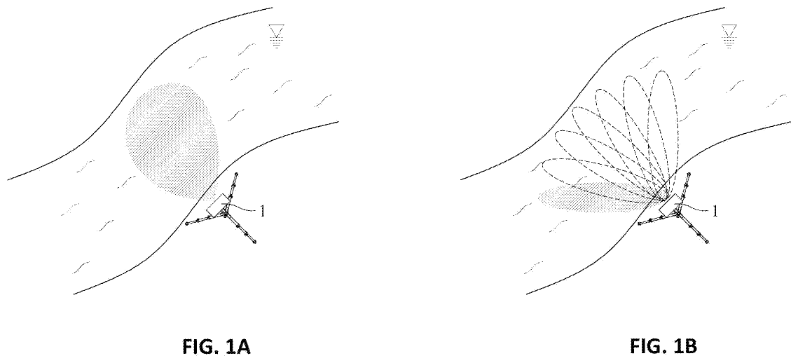

FIGS. 1A and 1B are conceptual diagrams of a transmission/reception antenna beam pattern of the present invention, and the present invention employs a method of simultaneously measuring flow velocities for several points at a time in a stream surface flow velocity measurement system to create a flow velocity profile for not only a specific point but also the entire river or river width. To this end, multiple beams generated through a digital beamforming algorithm are used, and an antenna module 1 including one transmission antenna and N reception array antennas, and an RF transmission/reception circuit corresponding thereto are provided.

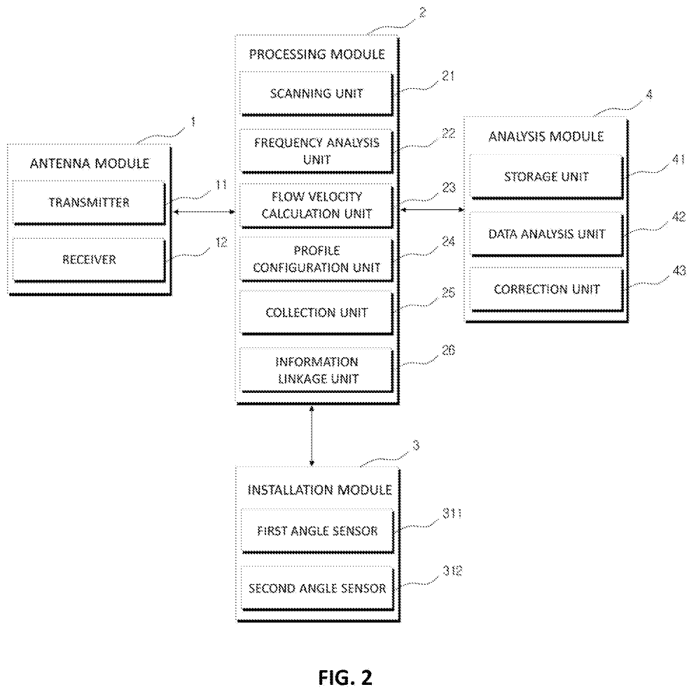

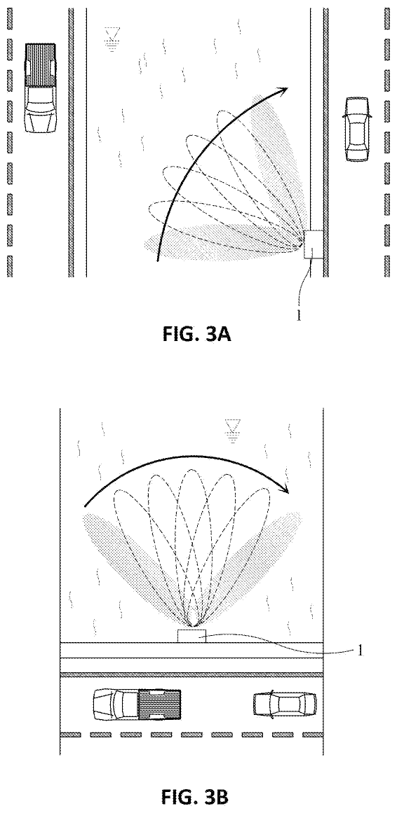

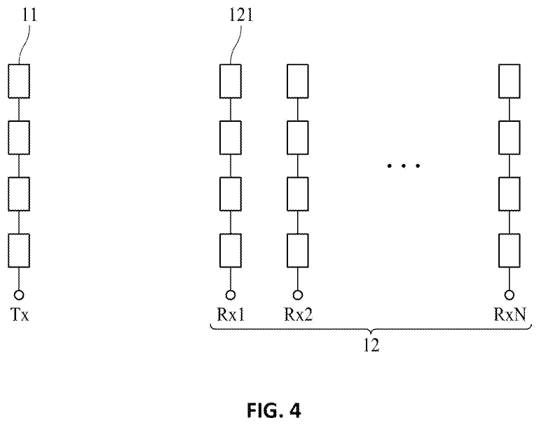

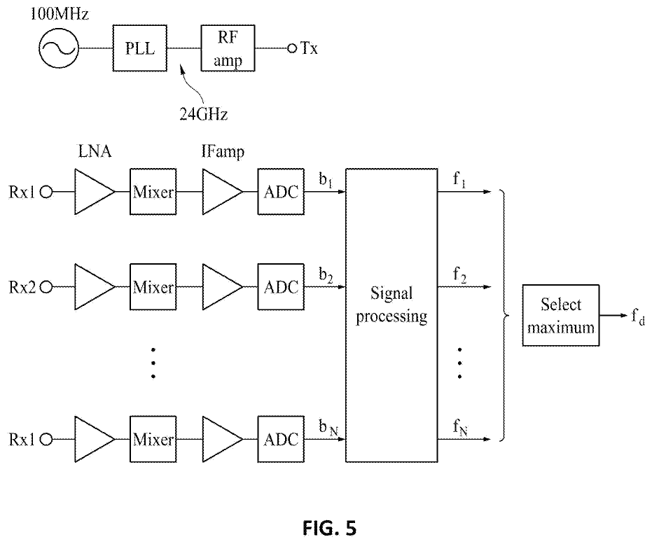

FIG. 2 is a block diagram illustrating a configuration and connection relationship according to an embodiment of the present invention, FIGS. 3A and 35 are structural diagrams illustrating an installation state according to an embodiment of the present invention, FIG. 4 is a flow velocity measurement conceptual diagram of a beamforming multibeam scan method according to an embodiment of the present invention, and FIG. 5 is a configuration diagram of a transmission/reception array antenna according to an embodiment of the present invention. The present invention includes an analysis module 4 to improve accuracy according to measurement data analysis in addition to the antenna module 1, a processing module 2, and an installation module 3 as a main configuration for the above-mentioned functions.

The antenna module 1 is a component basically corresponding to an antenna unit of a radar including transmitter 11 for transmitting a radio wave and a receiver 12 for receiving a reflected wave obtained by a radio wave transmitted through the transmitter being reflected off a water surface.

The transmitter 11 is a transmission antenna that transmits a radio wave in a frequency band set to a selected first region of a stream, and an ISM band of 1 to 100 GHz is used as a transmission frequency. An effective frequency range for surface flow velocity measurement is a 20 to 25 GHz band, and the present invention uses a 24 GHz band as a preferred embodiment.

The receiver 12 is a reception antenna, and includes plurality of reception arrays 121 each receiving a reflected wave of the radio wave from each of a plurality of second regions defined in the first region through digital beamforming and scanning.

That is, the transmitter 11 is provided with one antenna to transmit a radio wave to a wide region of the stream in the first region, and the receiver 12 receives reflected waves from a relatively narrow beam width region compared to the first region through N reception array 121 antennas, and thus may simultaneously receive reflected waves from several points by scanning.

The installation module 3 is a structure for installing the antenna module 1 on a river or riverside, basically includes a support supported on a floor to fix the antenna module 1 at a predetermined height in addition to an angle adjustment unit 31 for adjusting a vertical angle of the antenna module 1 and a direction adjustment unit 32 for adjusting a horizontal angle of the antenna module 1, and is configured so that the antenna module 1 can be fixedly installed in a set place.

In this instance, a first angle sensor 311 for measuring the vertical angle of the antenna module is installed in the angle adjustment unit 31, and a second angle sensor 321 for measuring the horizontal angle of the antenna module 1 is installed in the direction adjustment unit 32, so that the angle sensors may be used to check an incident angle of a reflected wave and a beamforming orientation angle, which will be described later. In addition, at a bottom of the support, a spike structure for strong support after installation on a floor surface Composed, of gravel or soil or a bridge may be formed, and a wheel having a locking device may be configured to Move a position for accurate measurement at the time of installation on a flat floor of a bridge or embankment.

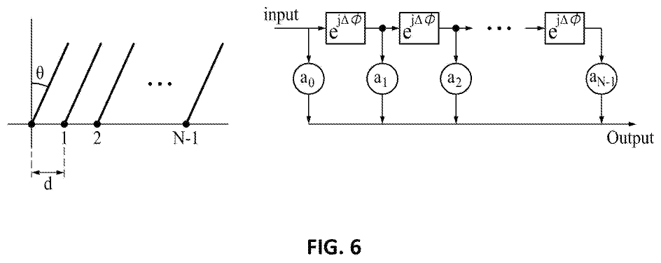

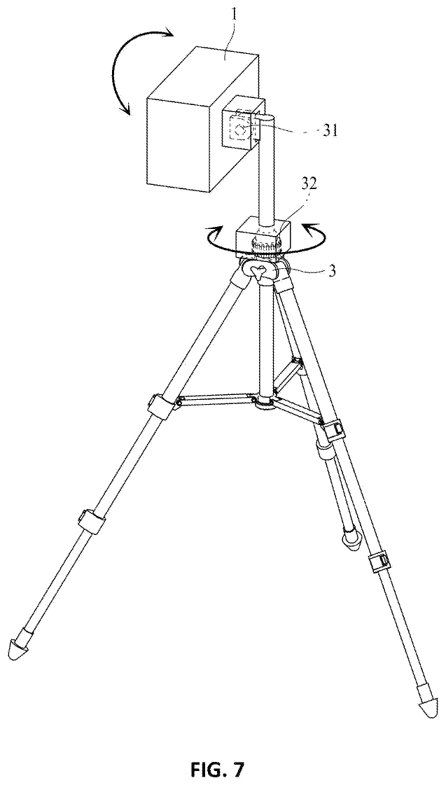

FIG. 6 a configuration diagram of array beamforming according to an embodiment of the present invention, and FIG. 7 is a configuration diagram of a transmission/reception circuit according to an embodiment of the present invention.

The processing module 2 is configured to control the antenna module 1 through a digital beamforming and beam scanning algorithm and process signals transmitted and received therefrom. As a detailed configuration, the processing module 2 includes a scanning unit 21, a frequency analysis unit 22, a flow velocity calculation unit 23, a profile configuration unit 24, a collection unit 25, and an information linkage unit 26.

In this instance, an operation cycle of the antenna module that is, a measurement cycle, may be changed by reflecting the weather or season. In other words, the measurement cycle may be increased during a period of low rainfall or when a probability of rainfall is low according to the weather forecast, and the measurement cycle may be decreased during period of high rainfall or when a probability of rainfall is high according to the weather forecast.

The scanning unit 21 is configured to perform a control operation so that the reception arrays 121 receive reflected waves from a plurality of different points within the first region, calculates a beam steering vector according to the vertical and horizontal angles of the antenna module 1, and performs beam scanning by reflecting the beam steering vector in reception input of the reception arrays 121.

That is, beam scanning is performed by multiplying the array reception input by the beam steering vector, and a scan beam width becomes narrower as the number of arrays increases.

FIG. 6 illustrates this, and each parameter is as follows.

$$Δϕ = \frac{2 π}{λ} d sin θ , {a}_{n} = {e}^{j \frac{2 π}{λ} d \cdot n \cdot sin {θ}_{0}} , n = 0 , 1 , 2 , ... , N - 1$$

⊖: incident angle of reflected wave, λ wavelength of frequency used,
⊖₀: beamforming orientation angle, N: number of reception arrays αₙ: steering vector, and a beamforming formula is as follows.

$$BF ( θ ) = {\sum }_{n = 0}^{N - 1} {a}_{n} {e}^{jn \cdot ΔΦ}$$

The frequency analysis unit 22 is configured to analyze a frequency due to the Doppler effect of a reflected wave received through the receiver 12. That is, when the transmitter 11 emits a transmitted radio wave of a specific frequency to the water surface, the transmitted radio wave is reflected in various directions on the water surface and a reflected wave is formed, which is received through the receiver 12, that is, each of the reception arrays 121. In this instance, a frequency difference occurs between the transmitted radio wave and the received reflected wave due to movement of water on the water surface, and this amount of frequency change is referred to as a frequency due to the Doppler effect.

As illustrated in FIG. 7, a spectrum of a flow velocity is measured using a. Fourier transform of a downlink signal (beat signal), and a frequency value of the measured spectrum is calculated as a frequency due to the Doppler effect.

The flow velocity calculation unit 23 is configured to calculate a surface flow velocity value using the frequency due to the Doppler effect. A formula for calculating the surface flow velocity using the frequency due to the Doppler effect derived through the frequency analysis unit 22 above is as follows.

$$v = \frac{{f}_{d} \cdot c}{2 {f}_{o}} cos θ ,$$

C: speed electromagnetic Wave, fₒ: transmission frequency of transmitter, and θ: vertical angle between transmission on frequency and water surface

The profile configuration unit 24 generates a floes velocity profile for the entire width of the target river by applying the surface velocity values calculated from a plurality of points.

A conventional electromagnetic wave type surface hydrometer may perform measurement at one point. Therefore, in general, after performing measurement several times with a set time period, an average value thereof is determined as a flow velocity, and a measurement position is moved to perform measurement using the same method in certain divided distances. After dividing a width of a stream at regular intervals on a bridge that usually crosses the stream, the flow velocity is measured for each section.

On the other hand, in the present invention, the flow velocity can be simultaneously measured for a plurality of points at the same time, and thus there is no inconvenience of moving a conventional measuring device several times. When measurement is performed through beam scanning corresponding to the width of the stream in the form illustrated in FIG. 4, the flow velocity is measured at multiple points across the entire width of the stream, and it is easy to create a flow velocity profile that reflects a part where the flown velocity partially changes due to a meandering stream section or a change in water depth.

In addition, flow velocities are simultaneously measured in a plurality of sections obtained by dividing the stream in a width direction in this way, and it is possible to calculate a flow rate according to flow velocity×area using longitudinal and transverse survey data at a measurement point. In this instance, since the flow velocity measured in the present invention becomes a surface velocity, it is necessary to apply a depth average flow velocity coefficient.

For a more accurate and usable flow velocity profile, it is necessary to reflect specific stream information.

The collection unit 25 provided therefor is configured to collect stream information including a width, a shape, and geographic information of a target stream and installation information including an installation location and a measurement direction of the antenna module 1. Information may be obtained from a geographic information system (GIS) such as an electronic map or an organization that manages streams, and installation Information including the installation location and the measurement direction of the antenna module 1 is reflected in the stream information including a width, a geographic shape, and geographic information of a measurement target. In other words, a geographical location of a stream and the stream at which measurement is performed, and a direction in which measurement is performed are identified and reflected in the flow velocity profile.

In this instance, the collection unit 25 may collect weather information, particularly information such as rainfall, from an organization that provides various weather information for each measurement date and time.

The information linkage unit 2G is configured to reflect surface flow velocity values calculated at a plurality of points together with the stream information and the installation information in connection with the profile configuration unit 24, that is, may geographically check at which point in the stream the generated flow velocity profile is obtained, and facilitates analysis and identification of flow velocity characteristics that can vary depending on the shape of the stream and the measurement location.

The analysis module 4 is configured to analyze and monitor flow velocity measurement results for each point calculated by the processing module over time, and when whether noise caused by various external factors according to an abnormal condition occurs is verified, or measurement is not smooth due to a change of a water depth of the stream, etc., the analysis module 4 may report this information to change the measurement point, thereby supporting measurement. The analysis module 4 includes storage unit 41, a data analysis unit 42, and a correction unit 43 as detailed components.

The storage unit 41 is a storage medium, and stores surface flow velocity values for a plurality of measurement points for the entire width of the target stream over time.

The data analysis unit 42 is configured to analyze data stored in the storage unit 41, monitor a change trend, and discriminate noise according a temporary change value. Basically, it is common that the flow velocity is constant or changes over a significantly long period of time except for a situation where a heavy rainfall occurs, etc. Therefore, in an outdoor environment, the e may be various factors that cause changes in measured data other than actual flow velocity changes.

In particular, erroneous detection may occur due to floating objects such as tree branches, river vegetation, or wild animals ire small and medium streams and valleys having relatively narrow widths, and such Measurement results may be significantly temporary, and thus may be determined as a noise factor when analyzing data and monitoring change trends.

At the same time, radar noise may occur in rain or snow conditions. Thus, when weather information is collected through the collection unit, data analysis is performed by reflecting the rain or snow conditions included in the weather information, and noise may be removed.

The correction unit 43 is configured to generate correction information related to a measurement position and an operation of the scanning unit 21 linkage with the information linkage unit 26 and an analysis result of the data analysis unit 42.

In other words, partial rapids may exist depending on the location and morphological characteristics of the stream, and due to partial changes in water depth due to gravel, rocks, and silt, measurement imbalance may occur according to simultaneous flow velocity measurement at several points Since these flow velocity imbalance factors interfere with calculating the average flow velocity and understanding the accurate state in monitoring river or stream conditions, it is necessary to recognize this fact and move the measurement location When unintentionally performing measurement in these areas.

As such, the correction unit 43 detects that an imbalance in the measured flow velocity occurs using an analysis result of the data analysis unit 42 and identifies a point where the imbalance occurs by linkage with the information linkage unit 26 to generate correction information, so that measurement can be performed by moving the measurement point based thereon. To this end, the installation position or measurement direction of the antenna module 1 may be modified, and depending on the number and structure of the reception arrays 121, a method of excluding a reflected wave at a point where the flow velocity imbalance occurs through operation control of the scanning unit 21 may be considered. Therefore, this content may be reflected in the correction information.

Through present invention, it is possible to simultaneously and accurately measure flow velocities at several points while minimizing an influence on day and night or weather conditions. In this way, it is possible to easily construct a flow velocity profile for the entire width of the stream.

In particular, it is possible to prevent measurement accuracy from decreasing as a result of erroneous detection due to floating objects such as tree branches, river vegetation, or wild animals in small and medium streams and valleys having relatively narrow widths, and it is possible to obtain accurate measurement results by reflecting various shapes of the target stream and changing the measurement location in the presence of an embankment or a point where a water depth is temporarily shallow due to stones, rocks, or sediments.

The right to the invention is not limited to the above-described embodiments, and is defined by the claims, and it is apparent that a person of ordinary skill in the art may make various modifications and adaptations within the scope of the rights recited in toe claims.

What is claimed is:

1. A system for measuring a stream surface flow velocity, the system comprising:
an antenna module including a transmitter configured to transmit a radio wave in a frequency band set to a selected first region in a target stream, and a receiver having plurality of reception arrays each receiving a reflected wave of the radio wave from each of a plurality of second regions defined within the first region through digital beamforming and scanning; and
a processing module including a scanning unit configured to perform a control operation so that the reception arrays receive reflected waves from a plurality of different points within first region, a frequency analysis unit configured to analyze a frequency due to a Doppler effect of a reflected wave received through the receiver, a flow velocity calculation unit configured to calculate a surface flow velocity value using the frequency due to the Doppler effect, and a profile configuration unit configured to create a flow velocity profile for an entire width of the target stream by applying surface flow velocity values calculated from a plurality of points.

2. The system according to claim 1, further comprising an installation module including an angle adjustment unit configured to adjust a vertical angle of the antenna module and a direction adjustment unit configured to adjust a horizontal angle of the antenna module, the installation module being configured for installation in a set place,
wherein the scanning unit calculates a beam steering vector according to the vertical and horizontal angles of the antenna module, and performs beam scanning b reflecting the beam steering vector in reception input of the reception arrays.

3. The system according to claim 1, wherein the processing module further includes a collection unit configured to collect stream information including a width, a shape, and geographic information of the target stream and installation information including an installation location and a measurement direction of the antenna module, and an information linkage unit configured to reflect surface flow velocity values calculated at a plurality of points together with the stream information and the installation information in connection with the profile configuration unit.

4. The system according to claim 1, further comprising an analysis module including a storage unit configured to store data of surface flow velocity values for a plurality of measurement points for an entire width of the target stream over time, and a data analysis unit configured to analyze data stored in the storage unit, monitor a change trend, and discriminate noise according to a temporary change value.

5. The system according to claim 4, wherein the analysis further includes a correction unit configured to generate correction information related to a measurement position and an operation of the scanning unit by linkage with the Information linkage unit and an analysis result of the data analysis unit.
